(19) United States
(12) Patent Application Publication
(10) Pub. No.: US 2026/0004780 A1
(43) Pub. Date: Jan. 1, 2026

(54) Enabling and Disabling Microphones and Voice Assistants

(71) Applicant: Sonos, Inc., Goleta, CA (US)

(72) Inventors: Kate Wojogbe, Santa Barbara, CA (US); Jason Yore, Santa Barbara, CA (US); Edwin Joseph Fitzpatrick, III, Boston, MA (US); Arthur Gordon, Seattle, WA (US); Mark S. Viscusi, Wrentham, MA (US)

(21) Appl. No.: 19/231,114

(22) Filed: Jun. 6, 2025

Related U.S. Application Data
(63) Continuation of application No. 17/957,691, filed on Sep. 30, 2022, now Pat. No. 12,327,556.
(60) Provisional application No. 63/250,900, filed on Sep. 30, 2021.

(51) Int. Cl. G10L 15/22; G06F 3/16; G08B 5/36; G10L 15/08; G10L 15/30; H04R 1/08; H04R 3/12

(52) U.S. Cl. CPC G10L 15/22; G06F 3/165; G08B 5/36; G10L 15/08; G10L 15/30; H04R 1/08; H04R 3/12; G10L 2015/088; G10L 2015/223

(57) ABSTRACT

An example playback device may include at least one microphone and a capacitive control disposed on a housing of the playback device. The playback device may be configured to receive information that causes the playback device to operate in a first state where the playback device is configured to (i) capture audio data via the at least one microphone and (ii) perform voice assistant wake word detection on audio data captured by the at least one microphone. While the playback device is operating in the first state, it may detect a selection of the capacitive control and based on the selection, transition to operate in a second state where the playback device is (i) configured to capture audio data via the at least one microphone and (ii) not configured to perform voice assistant wake word detection on audio data captured by the at least one microphone.

### CROSS-REFERENCE TO RELATED APPLICATIONS

This application is a continuation of U.S. application Ser. No. 17/957,691, filed Sep. 30, 2022, and titled “Enabling and Disabling Microphones and Voice Assistants,” which claims priority to U.S. Provisional Application No. 63/250,900 filed Sep. 30, 2021 and titled “Enabling and Disabling Microphones and Voice Assistants,” the contents of each of which are incorporated herein by reference in their entireties.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

Given the ever-growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of an example playback device.

FIG. 1D is a block diagram of an example playback device.

FIG. 1E is a block diagram of an example playback device.

FIG. 1F is a block diagram of an example network microphone device.

FIG. 1G is a block diagram of an example playback device.

FIG. 1H is a partially schematic diagram of an example control device.

FIG. 1I is a schematic diagram of example user interfaces of the example control device of FIG. 1H.

FIGS. 1J through 1M are schematic diagrams of example corresponding media playback system zones.

FIG. 2 is a schematic diagram of example media playback system areas.

FIG. 3 is an isometric diagram of an example playback device housing.

FIG. 4 is a diagram of an example headset assembly for the playback device of FIG. 3.

FIG. 5 is a schematic diagram of an example hardware user interface on a playback device.

FIG. 6 is a schematic diagram of an example mechanical microphone switch on a playback device.

FIG. 7 is a schematic diagram showing a timeline of example user interactions with a playback device.

FIG. 8A is a schematic diagram of an example user interface on a control device showing a microphone settings menu.

FIG. 8B is another schematic diagram of the example user interface of FIG. 8A.

FIG. 8C is another schematic diagram of the example user interface of FIGS. 8A-8B.

FIG. 8D is another schematic diagram of the example user interface of FIGS. 8A-8C.

FIG. 9 is a flowchart showing example operations for enabling and disabling a voice assistant on a playback device.

FIG. 10 is a schematic diagram of example microphone circuitry for a playback device.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Many consumer electronics devices, such as smart home devices, appliances, and other network devices, are equipped with one or more microphones that can be used to interact with a voice assistant service to which the device might be linked. For these types of “voice-enabled” devices, the microphones may be used to detect and process sound in the environment to determine if the sound includes speech containing voice input intended for a particular voice assistant service. For instance, if the device identifies a wake word in the detected sound that corresponds to the voice assistant service, the device may begin processing the detected sound locally and/or transmitting the detected sound to the voice assistant service, which is often facilitated by a remote (e.g., cloud-based) computing system.

In many cases, voice-enabled devices have a switch or similar control that a user may toggle to disable or mute the device's microphone(s) for the purpose of disabling the device's speech detection capabilities. For example, a friend whose name sounds similar to a voice assistant's wake word may come over, so the user may turn off device microphones to avoid triggering the voice assistant when speaking their friend's name. As another example, a user may issue voice commands that are intended for a first device but a second, unintended device within the vicinity may respond. To avoid this, the user may mute the microphone on the second device. As yet another example, a user might, based on their privacy or security preferences, temporarily disable the microphones on their devices to ensure that no voice data is recorded and potentially sent to the cloud.

For many voice-enabled devices, this pairing of voice assistant enablement with microphone enablement makes sense, as the primary purpose (e.g., the only purpose) of the device's microphone is to provide a gateway to the voice assistant service. However, for playback devices that are equipped with more advanced media playback system functions, such as those developed and sold by Sonos, Inc. (“Sonos”), playback device microphones may be utilized as a sensor for detecting sound within the environment to facilitate additional features.

These types of additional microphone-based features may take various forms, including audio calibration of the playback device (e.g., self-calibration) to improve the playback device's spectral response, and audio-based proximity detection (e.g., via ultrasonic audio tones) between playback devices and control devices of the media playback system, which in turn may enable a host of additional features. For example, playback devices in a media playback system may use audio-based proximity detection to facilitate transitioning a playback session from one device to another (e.g., from a portable device to a nearby stationary device or vice versa), forming synchrony groups with nearby devices, and/or setting up new playback devices, among other possibilities. In these examples as well as others, the sound that is detected by the microphones may be processed locally, and there may be no need to send any audio data to the cloud.

For playback devices that include these types of microphone-based capabilities, switching off all microphone functionality when the user only wants to disable their voice assistant can result in unnecessarily limiting the capabilities of the playback device. In these situations, the user is forced to choose between leaving their voice assistant enabled or foregoing all playback device features that use microphones when they want to disable their voice assistant, both of which may lead to unsatisfying user experiences.

To address these and other issues associated with turning microphones on and off to enable and disable voice assistants, example playback devices are discussed below that provide the ability to conveniently (e.g., via an on-device user interface) enable or disable voice assistant capabilities separately from the operation of the playback device's microphone(s). Advantageously, this may allow a user to quickly and easily disable voice assistant services when desired, while nonetheless continuing to benefit from other capabilities of the playback device that depend on its microphone(s) to function.

For example, a playback device may include a hardware control interface that incorporates a capacitive touch control or similar button that is selectable by a user to enable or disable the playback device's voice assistant features. When the voice assistant features are disabled, the playback device may still be capable of detecting sound in the environment (e.g., to facilitate other playback device features) via its one or more microphones, which may remain on. However, the playback device might not perform any audio processing to determine whether the detected sound includes speech containing voice input intended for the voice assistant service. The voice assistant may be disabled in other ways as well.

Additionally, a status LED may be positioned near the voice assistant control switch that is illuminated when the voice assistant is enabled and unilluminated when the voice assistant is disabled. This may provide the user with a relatively straight-forward visual indication of voice assistant status.

Separately, the playback device may include a switch (e.g., a mechanical switch) that a user may toggle between on and off positions to control the operability of the playback device's microphones. In this regard, although the examples discussed herein may refer to separating control of a playback device's microphones from control of its voice assistant functionality, the two might not be entirely independent. In particular, when a user moves the microphone switch to the off position, all microphone-dependent functionalities may be disabled, including voice assistant features, regardless of whether the voice assistant was currently enabled or disabled via the capacitive control.

In some embodiments, for example, a playback device is provided including at least one microphone, at least one processor, a non-transitory computer-readable medium, and program instructions stored on the non-transitory computer-readable medium that are executable by the at least one processor such that the playback device is configured to (i) receive information that causes the playback device to operate in a first state wherein the playback device is configured to (a) capture audio data via the at least one microphone and (b) perform voice assistant wake word detection on audio data captured by the at least one microphone, (ii) while the playback device is operating in the first state, detect a selection of the capacitive control, and (iii) based on the selection of the capacitive control while the playback device is operating in the first state, transition to operate in a second state wherein the playback device is (a) configured to capture audio data via the at least one microphone and (b) not configured to perform voice assistant wake word detection on audio data captured by the at least one microphone.

In another aspect, a non-transitory computer-readable medium in provided. The non-transitory computer-readable medium is provisioned with program instructions that, when executed by at least one processor, cause a playback device to (i) receive information that causes the playback device to operate in a first state wherein the playback device is configured to (a) capture audio data via at least one microphone and (b) perform voice assistant wake word detection on audio data captured by the at least one microphone, (ii) while the playback device is operating in the first state, detect a selection of the capacitive control, and (iii) based on the selection of the capacitive control while the playback device is operating in the first state, transition to operate in a second state wherein the playback device is (a) configured to capture audio data via the at least one microphone and (b) not configured to perform voice assistant wake word detection on audio data captured by the at least one microphone.

In yet another aspect, a method carried out by a playback device includes, (i) receiving information causing the playback device to operate in a first state wherein the playback device is configured to (a) capture audio data via at least one microphone and (b) perform voice assistant wake word detection on audio data captured by the at least one microphone, (ii) while the playback device is operating in the first state, detecting a selection of the capacitive control, and (iii) based on the selection of the capacitive control while the playback device is operating in the first state, transitioning to operate in a second state wherein the playback device is (a) configured to capture audio data via the at least one microphone and (b) not configured to perform voice assistant wake word detection on audio data captured by the at least one microphone.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

### II. Suitable Operating Environment

a. Suitable Media Playback System

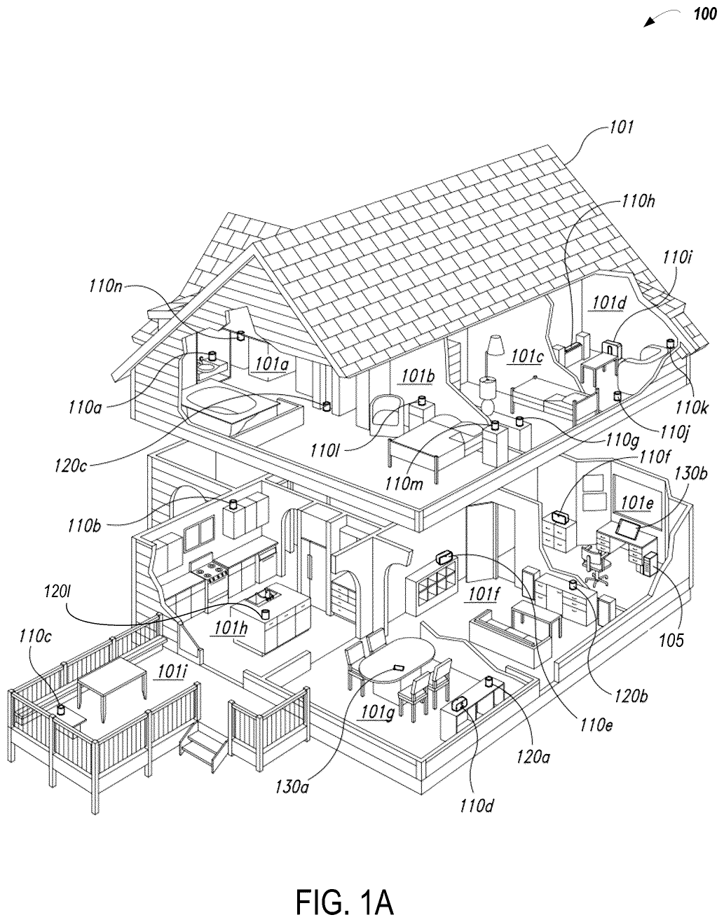

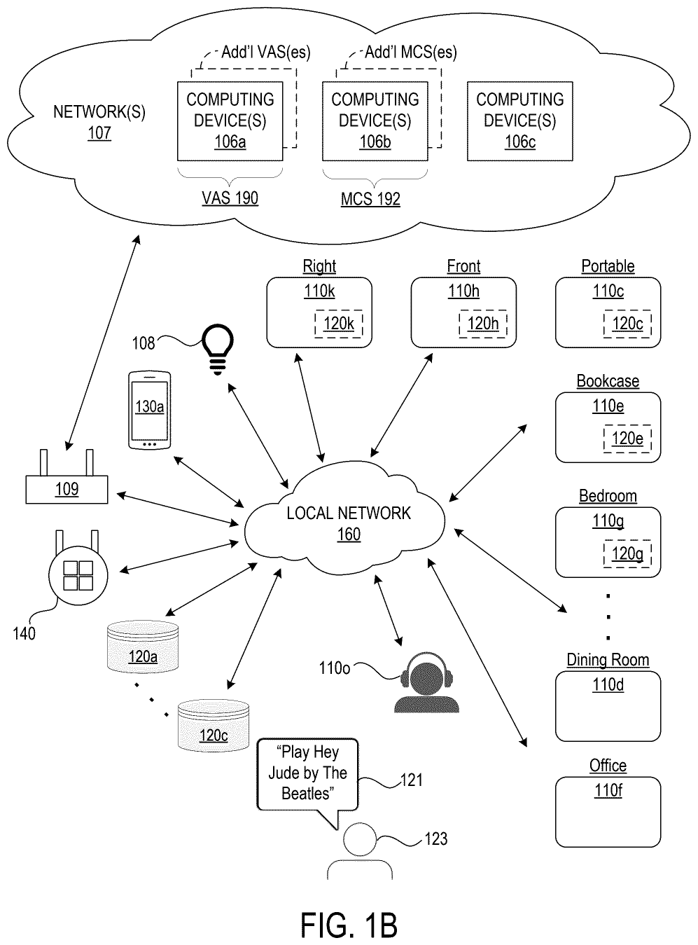

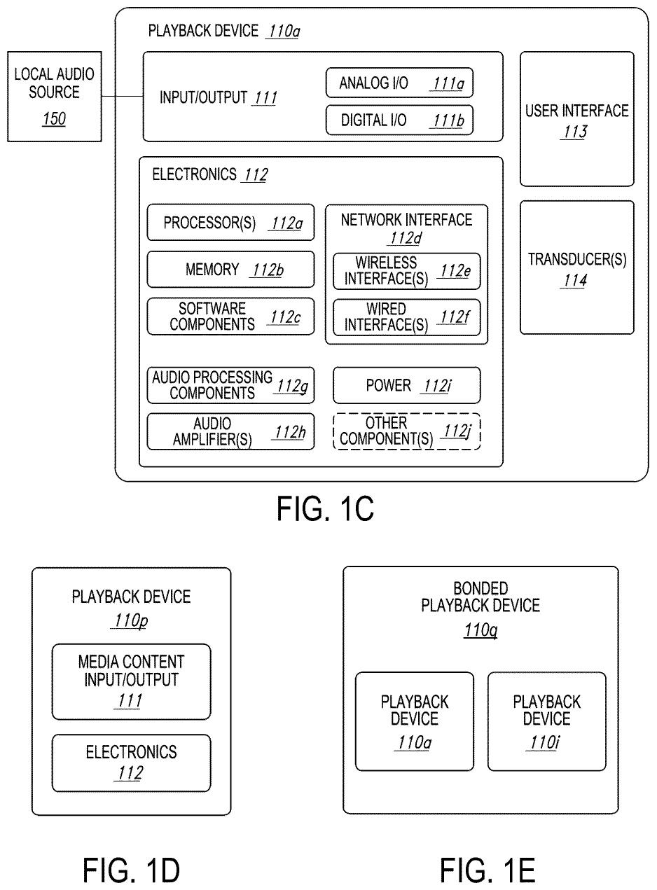

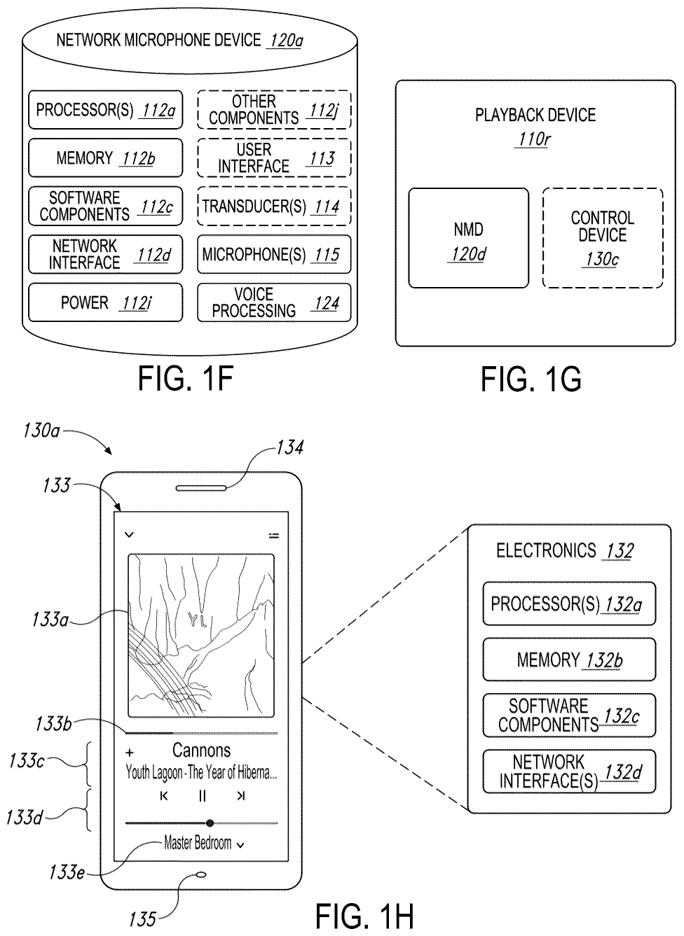

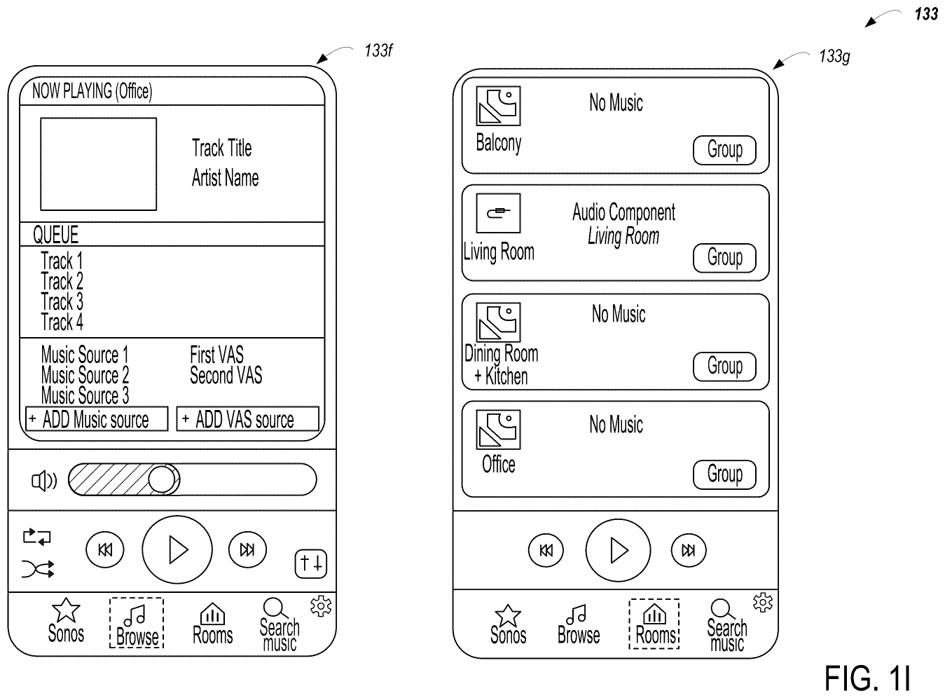

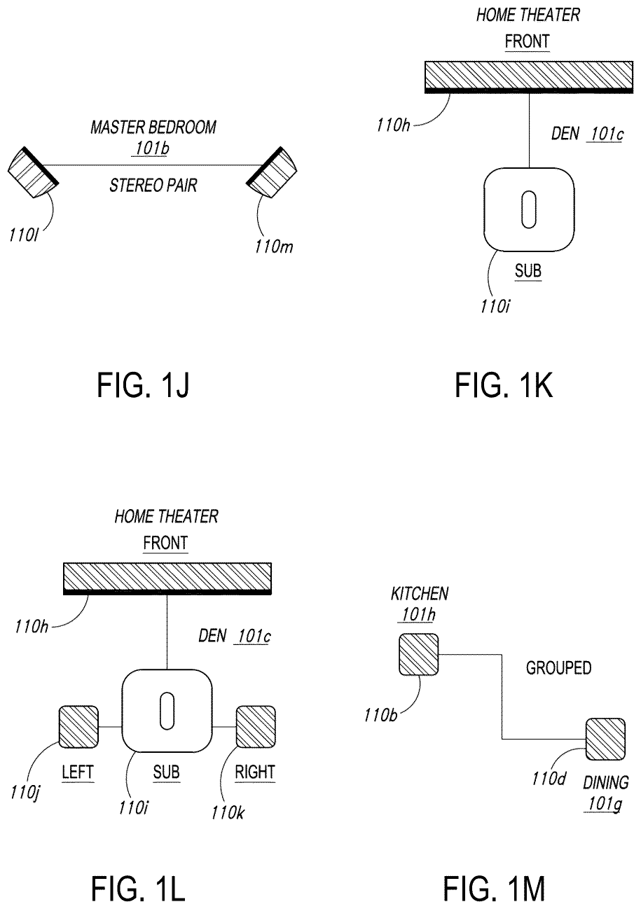

FIGS. 1A and 1B illustrate an example configuration of a media playback system (“MPS”) 100 in which one or more embodiments disclosed herein may be implemented. Referring first to FIG. 1A, a partial cutaway view of MPS 100 distributed in an environment 101 (e.g., a house) is shown. The MPS 100 as shown is associated with an example home environment having a plurality of rooms and spaces. The MPS 100 comprises one or more playback devices 110 (identified individually as playback devices 110a-o), one or more network microphone devices (“NMDs”) 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the MPS 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the MPS 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the MPS 100 is configured to play back audio from a first playback device (e.g., the playback device 110a) in synchrony with a second playback device (e.g., the playback device 110b). Interactions between the playback devices 110, NMDs 120, and/or control devices 130 of the MPS 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The MPS 100 can comprise one or more playback zones, some of which may correspond to the rooms in the environment 101. The MPS 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices.

Referring to FIG. 1B, the home environment may include additional and/or other computing devices, including local network devices, such as one or more smart illumination devices 108, a smart thermostat 140, and a local computing device 105 (FIG. 1A). Numerous other examples of local network devices (not shown) are also possible, such as doorbells, cameras, smoke alarms, televisions, gaming consoles, garage door openers, etc. In embodiments described below, one or more of the various playback devices 110 may be configured as portable playback devices, while others may be configured as stationary playback devices. For example, the headphones 1100 (FIG. 1B) are a portable playback device, while the playback device 110e on the bookcase may be a stationary device. As another example, the playback device 110c on the Patio may be a battery-powered device, which may allow it to be transported to various areas within the environment 101, and outside of the environment 101, when it is not plugged in to a wall outlet or the like.

With reference still to FIG. 1B, the various playback, network microphone, and controller devices and/or other network devices of the MPS 100 may be coupled to one another via point-to-point connections and/or over other connections, which may be wired and/or wireless, via a local network 160 that may include a network router 109. For example, the playback device 110j in the Den 101d (FIG. 1A), which may be designated as the “Left” device, may have a point-to-point connection with the playback device 110k, which is also in the Den 101d and may be designated as the “Right” device. In a related embodiment, the Left playback device 110j may communicate with other network devices, such as the playback device 110h, which may be designated as the “Front” device, via a point-to-point connection and/or other connections via the local network 160.

The local network 160 may be, for example, a network that interconnects one or more devices within a limited area (e.g., a residence, an office building, a car, an individual's workspace, etc.). The local network 160 may include, for example, one or more local area networks (LANs) such as a wireless local area network (WLAN) (e.g., a WIFI network, a Z-Wave network, etc.) and/or one or more personal area networks (PANs) (e.g. a BLUETOOTH network, a wireless USB network, a ZigBee network, an IRDA network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WIFI” can refer to several different communication protocols including, for example, Institute of Electrical and Electronics Engineers (IEEE) 802.11a, 802.11b, 802.11g, 802.12, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, 6 GHZ, and/or another suitable frequency.

The MPS 100 is configured to receive media content from the local network 160. The received media content can comprise, for example, a Uniform Resource Identifier (URI) and/or a Uniform Resource Locator (URL). For instance, in some examples, the MPS 100 can stream, download, or otherwise obtain data from a URI or a URL corresponding to the received media content.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the environment 101 (FIG. 1A).

In some implementations, the various playback devices 110, NMDs 120, and/or control devices 130 may be communicatively coupled to at least one remote computing device associated with a voice assistant service (“VAS”) and/or at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some embodiments, the various playback devices 110, NMDs 120, and/or control devices 130 may transmit data associated with a received voice input to a VAS configured to (i) process the received voice input data and (ii) transmit a corresponding command to the MPS 100. In some aspects, for example, the computing devices 106a may comprise one or more modules and/or servers of a VAS. In some implementations, VASes may be operated by one or more of SONOS®, AMAZON®, GOOGLE® APPLE®, MICROSOFT®, NUANCE®, or other voice assistant providers. In some implementations, MCSes may be operated by one or more of SPOTIFY, PANDORA, AMAZON MUSIC, YOUTUBE MUSIC, APPLE MUSIC, or other media content services.

In some embodiments, the local network 160 comprises a dedicated communication network that the MPS 100 uses to transmit messages between individual devices and/or to transmit media content to and from MCSes. In certain embodiments, the local network 160 is configured to be accessible only to devices in the MPS 100, thereby reducing interference and competition with other household devices. In other embodiments, however, the local network 160 comprises an existing household communication network (e.g., a household WIFI network). In some embodiments, the MPS 100 is implemented without the local network 160, and the various devices comprising the MPS 100 can communicate with each other, for example, via one or more direct connections, PANs, telecommunication networks (e.g., an LTE network or a 5G network, etc.), and/or other suitable communication links.

In some embodiments, audio content sources may be regularly added or removed from the MPS 100. In some embodiments, for example, the MPS 100 performs an indexing of media items when one or more media content sources are updated, added to, and/or removed from the MPS 100. The MPS 100 can scan identifiable media items in some or all folders and/or directories accessible to the various playback devices and generate or update a media content database comprising metadata (e.g., title, artist, album, track length) and other associated information (e.g., URIs, URLs) for each identifiable media item found. In some embodiments, for example, the media content database is stored on one or more of the various playback devices, network microphone devices, and/or control devices of MPS 100.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 110 may take the form of or include an on-board (e.g., integrated) network microphone device configured to detect audio content, including voice utterances from a user. For example, the playback devices 110c-110h, and 110k include or are otherwise equipped with corresponding NMDs 120c-120h, and 120k, respectively. A playback device that includes or is equipped with an NMD may be referred to herein interchangeably as a playback device or an NMD unless indicated otherwise in the description. In some cases, one or more of the NMDs 120 may be a stand-alone device. For example, the NMD 120l may be a stand-alone device. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 110 and 120 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 110e because it is physically situated on a bookcase. Similarly, the NMD 120l may be assigned the named “Island” because it is physically situated on an island countertop in the Kitchen 101h (FIG. 1A). Some playback devices may be assigned names according to a zone or room, such as the playback devices 110g, 110d, and 110f, which are named “Bedroom,” “Dining Room,” and “Office,” respectively. Further, certain playback devices may have functionally descriptive names. For example, the playback devices 110k and 110h are assigned the names “Right” and “Front,” respectively, because these two devices are configured to provide specific audio channels during media playback in the zone of the Den 101d (FIG. 1A). The playback device 110c in the Patio may be named “Portable” because it is battery-powered and/or readily transportable to different areas of the environment 101. Other naming conventions are possible.

As discussed above, an NMD may detect and process sound from its environment, including audio output played by itself, played by other devices in the environment 101, and/or sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word (also referred to herein as an activation word) associated with a particular VAS.

In the illustrated example of FIG. 1B, the NMDs 120 are configured to interact with the VAS 190 over the local network 160 and/or the router 109. Interactions with the VAS 190 may be initiated, for example, when an NMD identifies in the detected sound a potential wake word. The identification causes a wake-word event, which in tum causes the NMD to begin transmitting detected-sound data to the VAS 190. In some implementations, the various local network devices 105, 110, 120, and 130 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. Patent Publication No. 2017-0242653 published Aug. 24, 2017, and titled “Voice Control of a Media Playback System,” which is herein incorporated by reference in its entirety.

Upon receiving the stream of sound data, the VAS 190 may determine if there is voice input in the streamed data from the NMD, and if so the VAS 190 may also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the NIPS 100 or indirectly via the VAS 190. In some implementations, the VAS 190 may transmit to the NIPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 110e in the environment 101 (FIG. 1A) is in relatively close proximity to the NMD-equipped Living Room playback device 120b, and both devices 110e and 120b may at least sometimes detect the same sound. In such cases, this may require arbitration as to which device is ultimately responsible for providing detected-sound data to the remote VAS. Examples of arbitrating between NMDs may be found, for example, in previously referenced U.S. Patent Publication No. 2017-0242653.

In certain implementations, an NMD may be assigned to, or otherwise associated with, a designated or default playback device that may not include an NMD. For example, the Island NMD 120l in the Kitchen 101h (FIG. 1A) may be assigned to the Dining Room playback device 110d, which is in relatively close proximity to the Island NMD 120l. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Patent Publication No. 2017-0242653.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback devices 110, network microphone devices 120, and/or control devices 130. For example, the technologies herein may be utilized within an environment having a single playback device 110 and/or a single NMD 120. In some examples of such cases, the local network 160 (FIG. 1B) may be eliminated and the single playback device 110 and/or the single NMD 120 may communicate directly with the remote computing devices 106a-c. In some embodiments, a telecommunication network (e.g., an LTE network, a 5G network, etc.) may communicate with the various playback devices 110, network microphone devices 120, and/or control devices 130 independent of the local network 160.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WIFI, BLUETOOTH, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 150 via the input/output 111 (e.g., a cable, a wire, a PAN, a BLUETOOTH connection, an ad hoc wired or wireless communication network, and/or another suitable communication link). The local audio source 150 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 150 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 150. In other embodiments, however, the media playback system omits the local audio source 150 altogether. In some embodiments, the playback device 110a does not include an input/output 111 and receives all audio content via the local network 160.

The playback device 110a further comprises electronics 112, a user interface 113 (e.g., one or more buttons, knobs, dials, touch-sensitive surfaces, displays, touchscreens), and one or more transducers 114 (e.g., a driver), referred to hereinafter as “the transducers 114.” The electronics 112 is configured to receive audio from an audio source (e.g., the local audio source 150) via the input/output 111, one or more of the computing devices 106a-c via the local network 160 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g, one or more audio amplifiers 112h (referred to hereinafter as “the amplifiers 112h”), and power components 112i (e.g., one or more power supplies, power cables, power receptacles, batteries, induction coils, Power-over Ethernet (POE) interfaces, and/or other suitable sources of electric power).

In some embodiments, the electronics 112 optionally include one or more other components 112j (e.g., one or more sensors, video displays, touchscreens, battery charging bases). In some embodiments, the playback device 110a and electronics 112 may further include one or more voice processing components that are operably coupled to one or more microphones, and other components as described below with reference to FIGS. 1F and 1G.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the MPS 100. In some aspects, for example, the state data is shared during predetermined intervals of time (e.g., every 5 seconds, every 10 seconds, every 60 seconds) among at least a portion of the devices of the MPS 100, so that one or more of the devices have the most recent data associated with the MPS 100.

The network interface 112d is configured to facilitate a transmission of data between the playback device 110a and one or more other devices on a data network. The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the local network 160 (FIG. 1B) in accordance with a suitable wireless communication protocol (e.g., WIFI, BLUETOOTH, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

In some implementations, the power components 112i of the playback device 110a may additionally include an internal power source (e.g., one or more batteries) configured to power the playback device 110a without a physical connection to an external power source. When equipped with the internal power source, the playback device 110a may operate independent of an external power source. In some such implementations, an external power source interface may be configured to facilitate charging the internal power source. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The user interface 113 may facilitate user interactions independent of or in conjunction with user interactions facilitated by one or more of the control devices 130 (FIG. 1A). In various embodiments, the user interface 113 includes one or more physical buttons and/or supports graphical interfaces provided on touch sensitive screen(s) and/or surface(s), among other possibilities, for a user to directly provide input. The user interface 113 may further include one or more of lights (e.g., LEDs) and the speakers to provide visual and/or audio feedback to a user.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

In some embodiments, the playback device 110a may include a speaker interface for connecting the playback device to external speakers. In other embodiments, the playback device 110a may include an audio interface for connecting the playback device to an external audio amplifier or audio-visual receiver.

By way of illustration, SONOS, Inc. presently offers (or has offered) for sale certain playback devices including, for example, a “SONOS ONE,” “SONOS FIVE,” “PLAY: 1,” “PLAY: 3,” “PLAY: 5,” “PLAYBAR,” “PLAYBASE,” “CONNECT: AMP,” “CONNECT,” “MOVE,” “ARC,” “ROAM,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices.

In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with playback device 110i, is configured to render only the mid-range and high frequency components of a particular audio content, while the playback device 110i renders the low frequency component of the particular audio content. In some embodiments, the bonded playback device 110q includes additional playback devices and/or another bonded playback device.

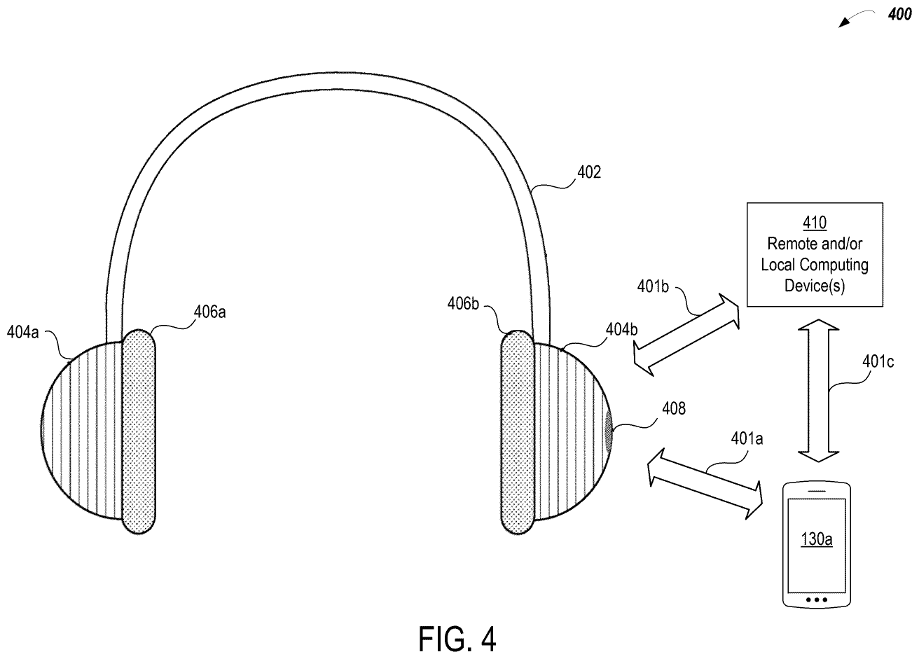

In some embodiments, one or more of the playback devices 110 may take the form of a wired and/or wireless headphone (e.g., an over-ear headset, an on-ear headset, or an in-ear headset). For instance, FIG. 4 shows an example headset assembly 400 (“headset 400”) for such an implementation of one of the playback devices 110. As shown, the headset 400 includes a headband 402 that couples a first earcup 404a to a second earcup 404b. Each of the earcups 404a and 404b may house any portion of the electronic components in the playback device 110, such as one or more speakers. Further, one or more of the earcups 404a and 404b may include a user interface for controlling audio playback, volume level, and other functions. The user interface may include any of a variety of control elements such as a physical button 408, a slider, a knob, and/or a touch control surface. As shown in FIG. 4, the headset 400 may further include ear cushions 406a and 406b that are coupled to earcups 404a and 404b, respectively. The ear cushions 406a and 406b may provide a soft barrier between the head of a user and the earcups 404a and 404b, respectively, to improve user comfort and/or provide acoustic isolation from the ambient (e.g., passive noise reduction (PNR)).

As described in greater detail below, the electronic components of a playback device may include one or more network interface components (not shown in FIG. 4) to facilitate wireless communication over one more communication links. For instance, a playback device may communicate over a first communication link 401a (e.g., a BLUETOOTH link) with one of the control devices 130 and/or over a second communication link 401b (e.g., a WIFI or cellular link) with one or more other computing devices 410 (e.g., a network router and/or a remote server). As another possibility, a playback device may communicate over multiple communication links, such as the first communication link 401a with the control device 130a and a third communication link 401c (e.g., a WIFI or cellular link) between the control device 130a and the one or more other computing devices 410. Thus, the control device 130a may function as an intermediary between the playback device and the one or more other computing devices 410, in some embodiments.

In some instances, the headphone device may take the form of a hearable device. Hearable devices may include those headphone devices (including ear-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.)

It should be appreciated that one or more of the playback devices 110 may take the form of other wearable devices separate and apart from a headphone. Wearable devices may include those devices configured to be worn about a portion of a subject (e.g., a head, a neck, a torso, an arm, a wrist, a finger, a leg, an ankle, etc.). For example, the playback devices 110 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

c. Suitable Network Microphone Devices (NMD)s

FIG. 1F is a block diagram of the NMD 120a (FIGS. 1A and 1B). The NMD 120a includes one or more voice processing components 124 and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise any or all of the components of the playback device 110a and further include the microphones 115 and voice processing components 124 (FIG. 1F). The microphones 115 are configured to detect sound (i.e., acoustic waves) in the environment of the playback device 110r, which may then be provided to voice processing components 124. More specifically, each microphone 115 is configured to detect sound and convert the sound into a digital or analog signal representative of the detected sound, which can then cause the voice processing component to perform various functions based on the detected sound, as described in greater detail below. In some implementations, the microphones 115 may be arranged as an array of microphones (e.g., an array of six microphones). In some implementations the playback device 110r may include fewer than six microphones or more than six microphones. The playback device 110r optionally includes an integrated control device 130c. The control device 130c can comprise, for example, a user interface configured to receive user input (e.g., touch input, voice input) without a separate control device. In other embodiments, however, the playback device 110r receives commands from another control device (e.g., the control device 130a of FIG. 1B).

In operation, the voice-processing components 124 are generally configured to detect and process sound received via the microphones 115, identify potential voice input in the detected sound, and extract detected-sound data to enable a VAS, such as the VAS 190 (FIG. 1B), to process voice input identified in the detected-sound data. The voice processing components 124 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word detection engines, one or more voice extractors, and/or one or more speech processing components (e.g., components configured to recognize a voice of a particular user or a particular set of users associated with a household), among other example voice processing components. In example implementations, the voice processing components 124 may include or otherwise take the form of one or more DSPs or one or more modules of a DSP. In this respect, certain voice processing components 124 may be configured with particular parameters (e.g., gain and/or spectral parameters) that may be modified or otherwise tuned to achieve particular functions. In some implementations, one or more of the voice processing components 124 may be a subcomponent of the processor 112a.

In some implementations, the voice-processing components 124 may detect and store a user's voice profile, which may be associated with a user account of the MPS 100. For example, voice profiles may be stored as and/or compared to variables stored in a set of command information or data table. The voice profile may include aspects of the tone of frequency of a user's voice and/or other unique aspects of the user's voice, such as those described in previously-referenced U.S. Patent Publication No. 2017-0242653.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The NMD 120a may use the microphone data (or transmit the microphone data to another device) for calibrating the audio characteristics of one or more playback devices 110 in the MPS 100. As another example, one or more of the playback devices 110, NMDs 120, and/or control devices 130 of the MPS 100 may by transmit audio tones (e.g., ultrasonic tones, infrasonic tones) that may be detectable by the microphones 115 of other devices, and which may convey information such as a proximity and/or identity of the transmitting device, a media playback system command, etc. As yet another example, the voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Controller Devices

FIG. 1H is a partially schematic diagram of one example of the control device 130a (FIGS. 1A and 1B). As used herein, the term “control device” can be used interchangeably with “controller,” “control device,” or “control system.” Among other features, the control device 130a is configured to receive user input related to the MPS 100 and, in response, cause one or more devices in the MPS 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the MPS 100. In other embodiments, as described above with respect to FIG. 1G, the control device 130a is integrated into another device in the MPS 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the MPS 100. The memory 132b can comprise data storage that can be loaded with one or more of the software components executable by the processors 132a to perform those functions. The software components 132c can comprise applications and/or other executable software configured to facilitate control of the MPS 100. The memory 132b can be configured to store, for example, the software components 132c, media playback system controller application software, and/or other data associated with the MPS 100 and the user.

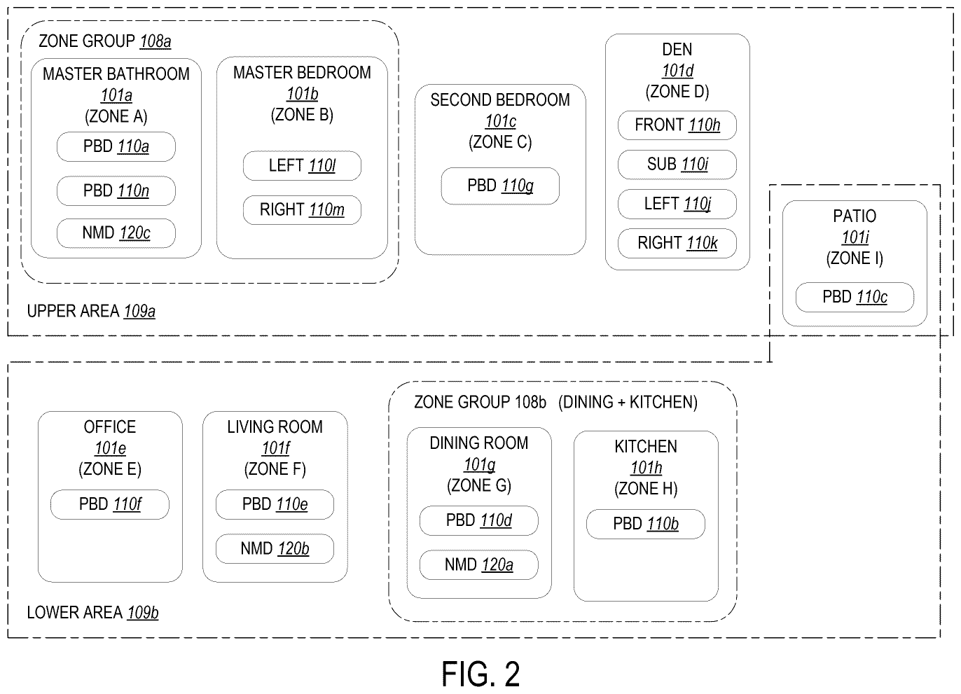

The network interface 132d is configured to facilitate network communications between the control device 130a and one or more other devices in the MPS 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.12, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1J through 2.

The user interface 133 is configured to receive user input and can facilitate control of the MPS 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system. FIG. 1I shows two additional user interface displays 133f and 133g of user interface 133. Additional examples are also possible.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

e. Suitable Playback Device Configurations

FIGS. 1J through 2 show example configurations of playback devices in zones and zone groups. Referring first to FIG. 2, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback zones 110g and 110h can be merged to form a merged group or a zone group 108b. The merged playback zones 110g and 110h may not be specifically assigned different playback responsibilities. That is, the merged playback zones 110h and 110i may, aside from playing audio content in synchrony, each play audio content as they would if they were not merged.

Each zone in the MPS 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1J, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1K, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1L shows the Front and SUB devices 110h and 110i further bonded with Left and Right playback devices 110j and 110k, respectively. In some implementations, the Right and Left devices 110j and 110k can be configured to form surround or “satellite” channels of a home theater system. The bonded playback devices 110h, 110i, 110j, and 110k may form a single Zone D (FIG. 2).

Playback devices that are merged may not have assigned playback responsibilities and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 2, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining +Kitchen”, as shown in FIG. 2. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device 110g is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1M). Identifiers associated with the Kitchen may indicate the same or similar information by virtue of the Kitchen being part of the Dining +Kitchen zone group 108b. Other example zone variables and identifiers are described below.

In yet another example, the MPS 100 may include variables or identifiers representing other associations of zones and zone groups, such as identifiers associated with Areas, as shown in FIG. 2. An area may involve a cluster of zone groups and/or zones not within a zone group. For instance, FIG. 2 shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

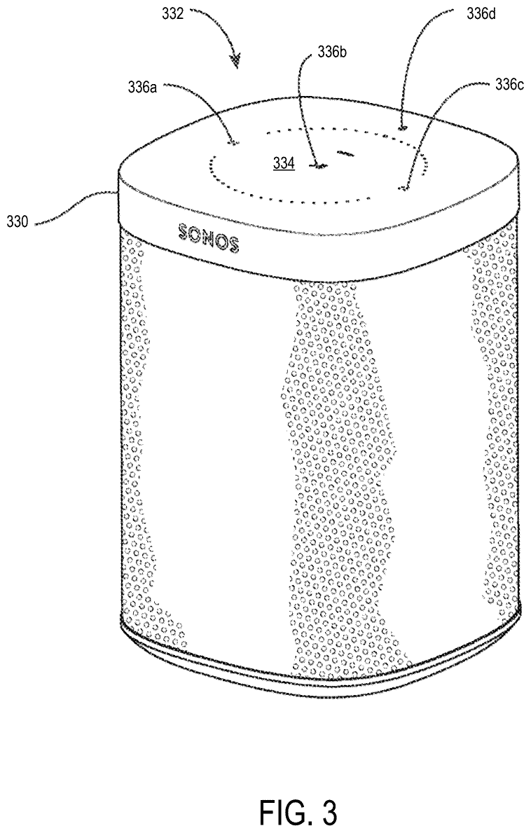

FIG. 3 shows an example housing 330 of the playback device 110 that includes a user interface in the form of a control area 332 at a top portion 334 of the housing 330. The control area 332 includes buttons 336a, 336b, and 336c for controlling audio playback, volume level, and other functions. The control area 332 also includes a button 336d for toggling the microphones 115 to either an on state or an off state. The control area 332 is at least partially surrounded by apertures formed in the top portion 334 of the housing 330 through which the microphones 115 (not visible in FIG. 3) receive the sound in the environment of the playback device 110. The microphones 115 may be arranged in various positions along and/or within the top portion 334 or other areas of the housing 330 so as to detect sound from one or more directions relative to the playback device 110.

In some embodiments, the playback device 110 may take the form of a wired and/or wireless headphone (e.g., an over-ear headset, an on-ear headset, or an in-ear headset). For instance, FIG. 4 shows an example headset assembly 400 (“headset 400”) for such an implementation of the playback device 110. As shown, the headset 400 includes a headband 402 that couples a first earcup 404a to a second earcup 404b. Each of the earcups 404a and 404b may house any portion of the electronic components in the playback device 110, such as one or more speakers. Further, one or more of the earcups 404a and 404b may include a user interface for controlling audio playback, volume level, and other functions. The user interface may include any of a variety of control elements such as a physical button 408, a slider, a knob, and/or a touch control surface. As shown in FIG. 4, the headset 400 may further include ear cushions 406a and 406b that are coupled to earcups 404a and 404b, respectively. The ear cushions 406a and 406b may provide a soft barrier between the head of a user and the earcups 404a and 404b, respectively, to improve user comfort and/or provide acoustic isolation from the ambient (e.g., passive noise reduction (PNR)).

### III. Example Techniques for Enabling and Disabling Voice Assistants and Microphones

As discussed above, an example playback device may be configured to provide a user with the ability to enable and disable voice assistant capabilities separately from controlling the operation of the playback device's microphone(s).

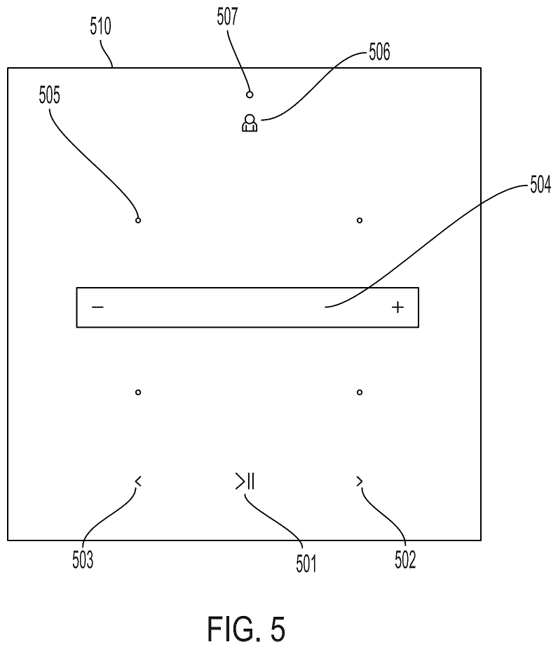

FIG. 5 depicts a schematic diagram of an example playback device 510 that may be configured in this way, which may generally correspond to any of the playback devices 110 discussed above. In FIG. 5, a top-down view of the playback device 510 is shown and various elements of a hardware user interface can be seen. For example, the hardware user interface may include transport controls such as a play/pause button 501, a skip forward button 502, and a skip backward button 503, each of which may take the form of capacitive touch controls, although physical buttons are also possible. The hardware user interface of the playback device 510 also incorporates a volume control bar 504, which may take the form of a groove or depression that includes a capacitive touch surface therein.

The playback device 510 also includes a set of one or more microphones, which are depicted in FIG. 5 as relatively small penetrations in the top surface of the playback device 510. For ease of reference, these will collectively be referred to hereafter as the microphones 505. As noted above, the microphones 505 may allow the playback device 510 to detect sound and perform various functions based on the recorded sound. In this regard, the playback device 510 may include any of the components of the NMDs 120 discussed above.

The hardware user interface of the playback device 510 also includes a voice assistant control button 506, which may take the form of a capacitive touch control and may be visually indicated by an icon, such as the icon of a generic person shown in FIG. 5. Other icons that may indicate the voice assistant control button 506 are also possible, such as a generic head or face, a speech bubble, among other possibilities that may imply the voice interactions facilitated by a voice assistant. Notably, however, the icon indicating the voice assistant control button 506 does not resemble a microphone, as might be found on many other types of conventional voice-enabled devices where a similarly situated button is used to disable a voice assistant by disabling all microphone functionality.

A status LED 507 may be positioned near the voice assistant control button 506 (e.g., incorporated into the area of the capacitive touch control) that may provide a visual indication of the status of the voice assistant. Thus, when the voice assistant is enabled, the LED 507 may be illuminated and when the voice assistant is disabled, the LED 507 may be unilluminated. This may allow a user to determine the status of the voice assistant by glancing at the top of the playback device 510, as well as confirm that a selection of the voice assistant control button 506 was registered correctly by observing the LED 507 turn on or off. While the examples herein refer to a variety of capacitive touch-based buttons, one having ordinary skill will appreciate that any one or more of the buttons may alternatively be implemented as mechanical buttons.

In some implementations, the LED 507 may have different illumination states (e.g., different colors) that may correspond to different levels of voice assistant functionality, which will be discussed further below.

In the example of FIG. 5, transitions between enabled and disabled status of the voice assistant based on selections of the voice assistant control button 506 may be implemented by software, as the playback device 510 may be configured to detect a selection of the capacitive touch controls and update the voice assistant status accordingly. In a similar way, the status of the voice assistant on playback device 510 may also be updated based on information received from other devices. For example, a user may control various features and settings of the playback device 510 via a media playback system controller application operating on a control device, such as a control device 130 discussed above. Thus, the playback device 510 might receive an indication of a command from the control device 130 to disable (or enable) the voice assistant. As another example, the playback device 510 may be grouped or bonded with one or more other playback devices for synchronous playback of audio content, some or all of which may include a voice assistant control button similar to the voice assistant control button 506. If the user presses the voice assistant control button on one of the other grouped or bonded playback devices to disable (or enable) the voice assistant, that playback device may transmit an indication of a command to the playback device 510 to update its voice assistant status accordingly. The playback device 510 might receive an indication of a command to update its voice assistant status from various other sources as well.

Similarly, if the playback device 510 detects a selection of the voice assistant control button 506 indicating a command to disable voice assistant functionality, the playback device 510 may transmit an indication of a command to each other playback device that is grouped or bonded with the playback device 510 to also disable voice assistant functionality on those other playback devices. On the other hand, if the playback device 510 detects a selection of the voice assistant control button 506 indicating a command to enable voice assistant functionality, the playback device 510 might not transmit an indication of a corresponding command to each other playback device that is grouped or bonded with the playback device 510. Rather, a given playback device may be configured to only enable voice assistant functionality based on commands issued directly to the given playback device (e.g., via a hardware interface, or based on a command received from a control device that receives configuration inputs for the given playback device). Alternatively, the playback device 510 may transmit an indication of a corresponding command to each other playback device that is grouped or bonded with the playback device 510 to enable voice assistant functionality, but to also store an indication that the voice assistant enabled status is a temporary state that depends on the grouping status of the playback device. As a result, if any of the other playback devices are ever ungrouped or unbonded from the playback device 510, they may automatically revert their voice assistant status to a disabled state. Other examples are also possible.

In the discussion of the example playback device 510 thus far, it has been assumed that a user first linked the playback device 510 with a voice assistant service. However, it will be appreciated that some users might not use voice assistant services, or might prefer not to link them with some devices, such as the playback device 510. In situations where there is no voice assistant linked to the playback device 510, the LED 507 may remain unilluminated, and selecting the voice assistant control button 506 may have no effect. Alternatively, selecting the voice assistant control button 506 may trigger an audible announcement or suggestion that a voice assistant may be linked in a settings menu of an associated control device. Similarly, selecting the voice assistant control button 506 when no voice assistant is linked may cause the playback device 510 to send an indication to one or more control devices of the media playback system, which in turn may cause the control devices to present a notification or similar suggestion (e.g., via a media playback system controller application) regarding the playback device's ability to be linked to a voice assistant service. Other examples are also possible.

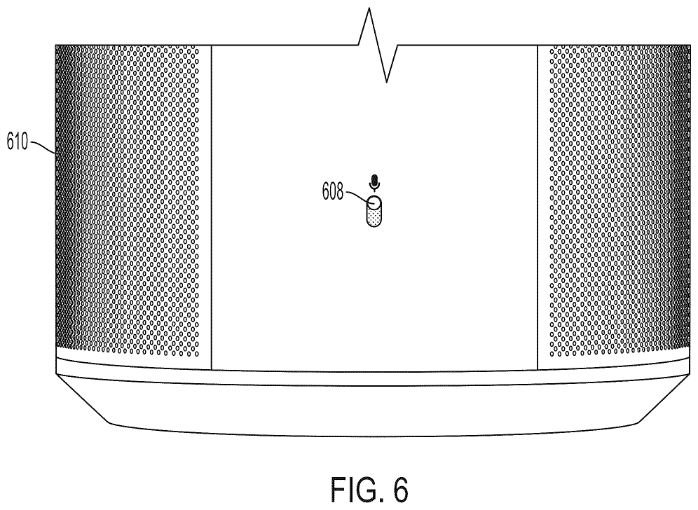

Turning to FIG. 6, another example playback device 610 is shown. The playback device 610 may be similar to, or the same as, any of the playback devices 110 or the playback device 510 discussed above. As shown in FIG. 6, the playback device 610 includes a microphone switch 608 that may be used to turn the microphones of the playback device 610 on or off. Accordingly, the microphone switch 608 may be positioned near a microphone icon.

Unlike the software controllable voice assistant control button 506, the microphone switch 608 may be embodied in a mechanical switch that physically enables and disables the microphones of the playback device 610 via hardware. For example, when the microphone switch 608 is in the “ON” position, a microphone control circuit may be closed and the microphones may receive power (e.g., via a voltage regulator). However, when the microphone switch 608 is in the “OFF” position, the microphone circuit may be open and the microphones may be incapable of receiving power necessary for operation. In some cases, the microphone switch 608 may be alternatively implemented as a capacitive touch button.

Further, unlike the easily glanceable and accessible position of the voice assistant control button 506 shown in FIG. 5, which some users might utilize with some frequency, the microphone switch 608 may be positioned in a less accessible, but also less noticeable area, such as on the bottom rear of the playback device 610, as shown in FIG. 6. This may reflect that users might not need to access the microphone switch 608 as frequently if the voice assistant can be disabled via the separate voice assistant control button. For example, users may generally prefer to keep the microphones on, along with any non-voice assistant features that are enabled, in most or all situations. In this regard, and similar to the initial linking of voice assistant services discussed above, a user may initially opt to enable the playback device 610 to use its microphones to capture sound for other, non-voice assistant related features (e.g., during an initial setup process).

As noted above, these other features that depend on microphone operation may include calibration features, such as a self-calibration capability whereby the playback device 610 analyzes sound detected in its environment to determine adjustments to its own frequency response that will improve its audio quality. In some cases, during a self-calibration process, the playback device 610 may perform all of the audio processing locally, and thus no captured audio data may need to be sent to the cloud. In some other cases, if the self-calibration process requires providing some or all portions of the captured audio data to the cloud for processing, audio data may only be captured during the self-calibration process, and not at any other times.

Another such feature involves the detection of high frequency (e.g., ultrasound or near ultrasound) audio tones that may facilitate certain proximity-based functionalities, such as transferring a playback session to (or from) a nearby device. For example, the playback device 610 may be a portable playback device that is currently playing back audio content. A user may input a given command (e.g., a long press of a play/pause button) on the playback device 610 that transmits an instruction for each other playback device in the media playback system to emit a unique ultrasonic audio tone that identifies itself. The playback device 610 may use its microphones to capture audio data and then determine, based on the characteristics (e.g., signal strength) of any detected audio tones, which other playback device is closest to the playback device 610 and transfer the playback session to that device. Similar to the self-calibration feature discussed above, the audio processing related to this type of playback session transfer, as well as other features that may utilize ultrasonic proximity detection, may be handled locally by the playback device 610. In these types of proximity-based applications that use, e.g., ultrasonic audio tones, the audio data captured by the microphones may be filtered (e.g., through a high-pass filter) such that only pertinent audio data, namely the ultrasonic audio tones, is processed by the playback device. In cases where this feature is combined with the self-calibration feature, full frequency audio data capture may only take place during the self-calibration process, while only ultrasonic tones are captured the rest of the time.

The voice assistant services discussed thus far are distinct from these types of locally-processed audio features because they generally involve transmitting captured audio data to the cloud to handle more advanced audio processing tasks, such as performing speech recognition and determining what commands are present in the captured speech. However, in some implementations, a playback device may be configured to facilitate a voice assistant service that only relies on local processing by the playback device, or perhaps by the playback device and one or more other playback devices within the local media playback system, which may be referred to herein as a “local” voice assistant service. For instance, a playback device that is provisioned with a local voice assistant service may be configured to recognize and respond to a relatively limited set of voice commands that are focused on media playback system control (e.g., transport controls, volume controls, grouping/ungrouping controls). Accordingly, the computational resources required to implement a local voice assistant service may be relatively less than those required for a cloud-based voice assistant service.

When a local voice assistant is available, a playback device such as playback device 610 may be configured with both the local voice assistant as well as a cloud-based voice assistant. In these situations, the operation of the playback device's voice assistant control button may be adapted in various ways. As one possibility, all voice assistants may be treated the same regardless of where the associated processing of sound data takes place. Thus, selecting the voice assistant control button may enable and disable both voice assistants together.

As another possibility, rather than toggling between enabled and disabled voice assistant states, selecting the voice assistant control button may cycle through three different voice assistant states-a first state in which all voice assistants are enabled, a second state in which neither voice assistant is enabled, and a third state in which the local voice assistant is enabled but the cloud-based voice assistant is disabled. The behavior of the LED may also be adapted accordingly. For example, the LED may be illuminated in a different color for each of the first and third states. Further, these behaviors may be configurable by the user in a voice assistant settings menu of a media playback system controller application, including the option to couple or decouple the local and cloud-based voice assistant services, the selection of LED colors associated with voice assistant states, and so on.

Similar to the examples discussed above with respect to FIG. 5, the playback device 610 may be grouped or bonded with one or more other playback devices for synchronous playback of audio content, some or all of which may include a microphone switch that is separate from a voice assistant control button (e.g., some playback devices may only have a microphone switch and no voice assistant control button). In these situations, if the microphone switch takes the form of a capacitive touch sensor, the intra-group behaviors and messaging among the playback devices may be substantially the same as the discussion above related to the voice assistant control button 506. For example, commands to turn the microphone of a given playback device on or off may be relayed to the other playback devices in the group, which may mirror the microphone state of the playback device that received the command.

However, in some cases, some or all of the playback devices in a synchrony group or bonded zone may include a mechanical microphone switch, similar to the microphone switch 608 shown in FIG. 6. In these situations, it may be more challenging to mirror the microphone state across playback devices within the group, although there are several possible options.

As one possibility, each playback device that includes a mechanical microphone switch may include, as part of the switch, a mechanical actuator that may be operated by the playback device to move the microphone switch without user input. For example, if a user manually toggles the microphone switch 608 of the playback device 610 to the OFF position, the playback device 610 may transmit an indication of a command to each other playback device that is grouped or bonded with the playback device 610 that causes the other playback devices to use their respective actuators to move their own microphone switches to the OFF position. A similar result may occur if the user manually toggles the microphone switch 608 of the playback device 610 to the ON position, such that each other playback device that is grouped or bonded with the playback device 610 uses its respective actuator to move its own microphone switch to the ON position. On the other hand, the playback devices may be configured such that their actuators are only capable of moving the microphone switch in one direction, to the OFF position. In this way, a given playback device's microphone switch may only be moved to the ON position if a user manually moves it there. Other implementations involving a mechanical actuator as part of the microphone switch are also possible.

As another possibility, if a user manually toggles the microphone switch 608 of the playback device 610 to either the ON position or the OFF position, the playback device 610 and one or more other devices within the media playback system (e.g., each grouped/bonded playback device, a control device), may be configured to alert the user that the change to the microphone setting of the playback device 610 are not being applied to other playback devices that are grouped or bonded with the playback device 610. For example, upon moving the microphone switch 608 in either direction, the playback device 610 may initially output an audible notification that signals the change in microphone state, such as a “microphone off” audio tone and/or a verbal cue (e.g., “The microphone is OFF”). Following this initial notification, the playback device 610 may output another notification indicating the status of any grouped or bonded playback devices, such as a verbal cue. A verbal cue of this kind might be general (e.g., “The microphone status of grouped speakers has not changed”) or it might be specific depending on the context of the microphone change and what other playback devices are involved (e.g., “The microphone of the Kitchen speaker is still ON”). Each of these audible notifications may be duplicated at each grouped/bonded playback device as well.

In addition to an audible notification at the playback device 610, one or more control devices of the media playback system might display a notification indicating that the microphone status of the playback device 610 is not aligned with the microphone status of the other playback devices that are grouped or bonded with the playback device 610. For instance, a software control application for the media playback system may display a notification that indicates the differing microphone settings. For example, a notification might be displayed within a Rooms menu, as shown in FIG. 1I, such that the indication of the playback device 610 and the other grouped/bonded playback devices includes a flag that signifies the differing microphone settings. Alternatively, a notification might be displayed on every screen of the software control application and may persist until the user dismisses it. Other examples are also possible.

In these situations, although the microphone status of the other grouped/bonded playback devices are not adjusted in response to the user moving the microphone switch 608 of the playback device 610, the playback device 610 might nonetheless transmit an indication of a command to each other playback device that is grouped or bonded with the playback device 510 to disable voice assistant functionality on those other playback devices, which may be accomplished without articulating a mechanical switch, as discussed above.

As yet another possibility, if a user manually toggles the microphone switch 608 of the playback device 610 to the OFF position, the playback device 610 may transmit an indication of one or more commands to each other playback device that is grouped or bonded with the playback device 610 that causes the other playback devices to (i) disable voice assistant functionality and (ii) discontinue capturing audio data via the microphones for any purpose. In these situations, the microphone switches for the other playback devices may remain in the ON position but the microphones will not be used (although they may remain powered), simulating the result of their respective switches being moved to the OFF position. As above, one or more notifications may be presented, either via the involved playback devices or a control device, indicating this change.

If one of these other playback devices is removed from the playback group while its microphone is in this type of “simulated off” state, it may transition operating in accordance with its mechanical microphone switch by resuming audio data capture for microphone-dependent tasks-although possibly not for voice assistant functionality, which may remain disabled as discussed in some previous examples. Alternatively, if a playback devices is removed from the playback group while its microphone is in this type of “simulated off” state, it may remain in this state (and notifications regarding this state may persist in a software controller application of via an LED light on the playback device) until a user resets the microphones by moving the microphone switch OFF and then back ON. As with some other embodiments discussed herein, a playback device might be configured such that neither microphone capability nor voice assistant functionality can transition from a disabled state to an enabled state without an express and unambiguous command to do so from a user.

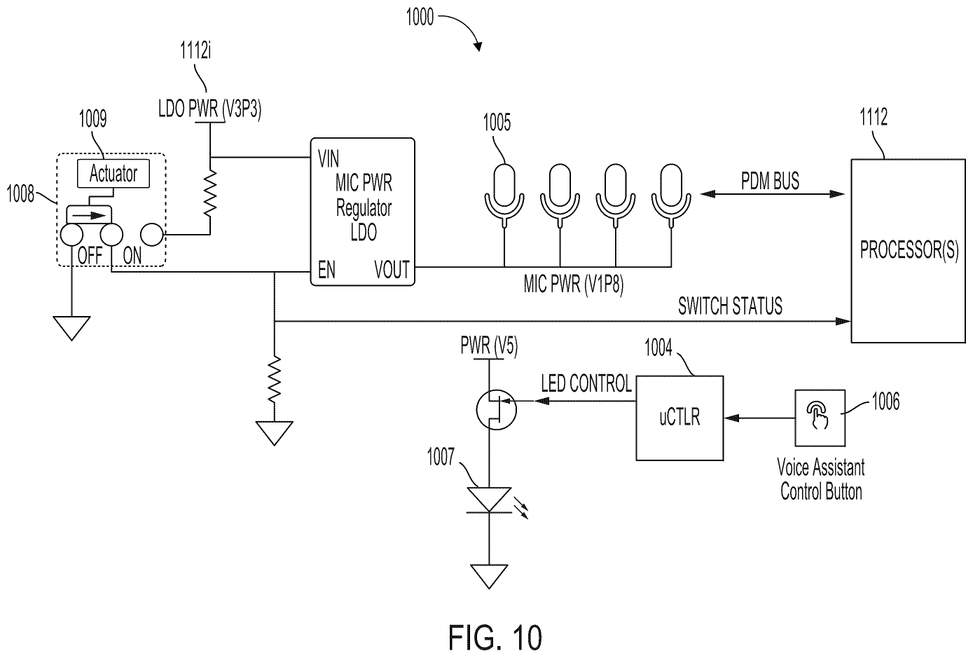

Finally, as will be appreciated from the discussion above and a review of FIG. 10, the other playback devices that are grouped or bonded with the playback device 610 cannot achieve a similar result of simulating the functionality of playback device 610 if their microphone switches begin in the OFF position, and the user manually toggles the microphone switch 608 of the playback device 610 to the ON position. In these situations, the microphones of the other playback devices are not powered and will not function unless their respective microphone switches are manually turned on by the user.

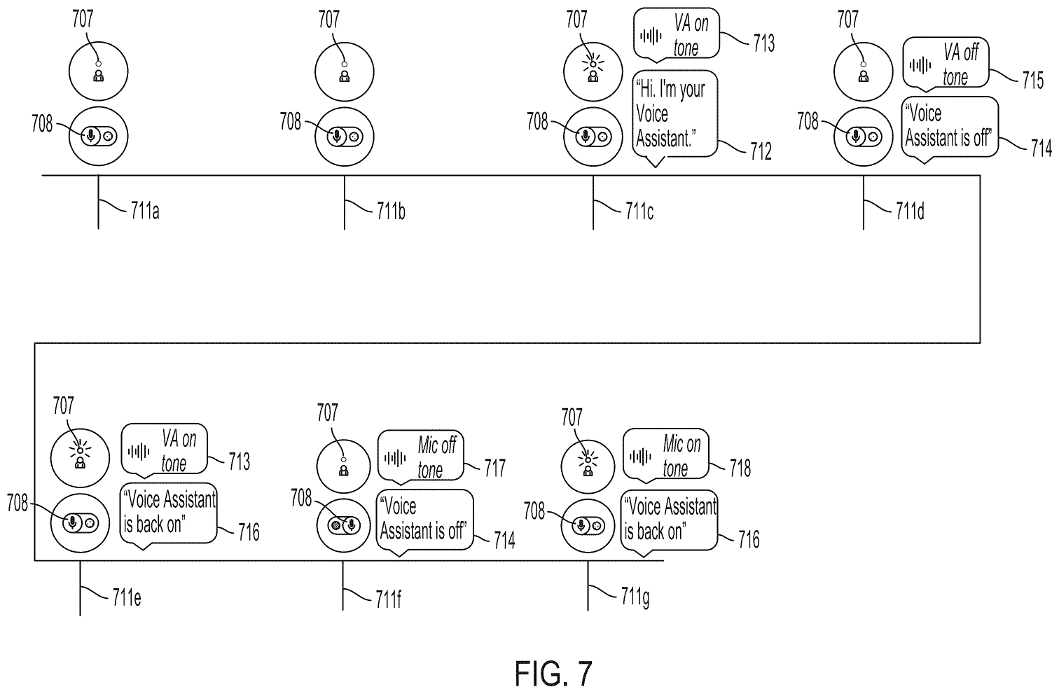

Turning to FIG. 7, an example timeline is shown that illustrates various states of an example playback device, including a corresponding illustration of the voice assistant control button with associated LED and the microphone switch. Starting at a first point in time 711a, the playback device may not be configured for any microphone-based features, although the microphone switch 708 may initially be in the ON position. For instance, the first point in time 71la may correspond to an “out-of-the-box” state of a new playback device, upon initial setup in a user's media playback system. Accordingly, the LED 707 associated with the voice assistant control button may be unilluminated.

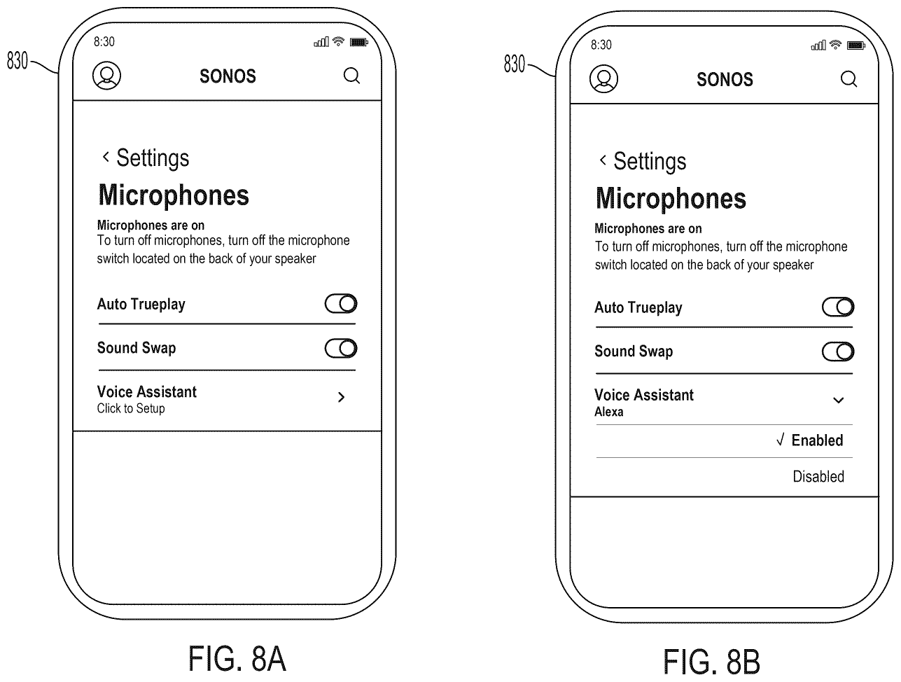

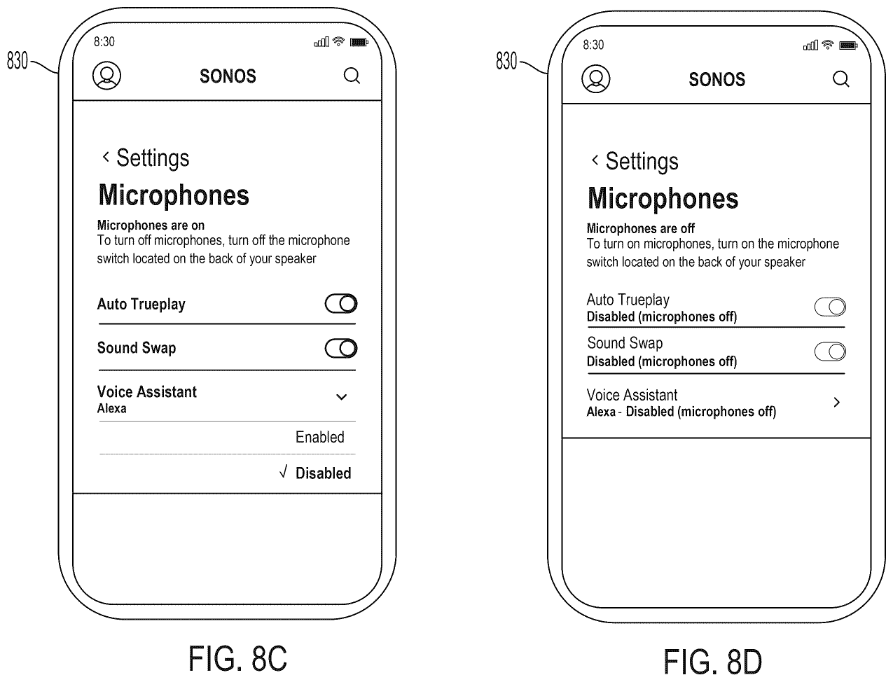

Moving to the second point in time 711b, the user may enable (e.g., during initial device setup) one or more microphone-based features of the playback device. Although there may be no change to either the microphone switch 708 or the LED 707, the enablement of these features may be reflected in a settings menu of a media playback system controller application running on the user's control device. One possible example of this type of menu can be seen in FIG. 8A, which shows a microphone settings menu displayed on a user interface of an example control device 830. As shown in FIG. 8A, the menu includes an indication that the microphones are turned on, reflecting the position of the microphone switch 708, and further includes indications that a self-calibration feature (i.e., “Auto Trueplay”) and a proximity-based playback session transition feature (i.e., “Sound Swap”) are both enabled. The menu also indicates that a voice assistant is not yet set up on the playback device and provides a selectable indication to do so. The microphone settings menu shown in FIG. 8A may take other forms as well, and may include options for enabling other microphone-based features. Further, an indication of the microphone and/or voice assistant status for a given playback device may displayed in other views of the media playback system controller application as well, such as a Rooms menu (e.g., the Rooms menu shown in FIG. 1I), among other possibilities.

Moving to the third point in time 711c shown in FIG. 7, the microphone switch 708 remains in the ON position and the user may set up a voice assistant for operation on the playback device. For example, the user may link a cloud-based voice assistant service to the playback device. Accordingly, the LED 707 will become illuminated, as illustrated in FIG. 7. In addition, the playback device may output an audible indication 712 (e.g., based on audio data received from the voice assistant service) that announces the enablement of the voice assistant. Similarly, the playback device may output a separate audible indication 713, which may be a tone or series of tones that signal the enablement of the voice assistant.

FIG. 8B shows an updated version of the microphone settings menu that may be displayed on the control device 830 at the third point in time 711c. An indication of the voice assistant (e.g., the name of the voice assistant) is now provided, along with an indication of the voice assistant's status. In FIG. 8B, the voice assistant “Alexa” is shown as enabled, consistent with the illuminated LED 707.

At the fourth point in time 711d, the user may disable the voice assistant while leaving the microphone switch 708 in the ON position. As noted above, the user might disable the voice assistant in various ways. As one possibility, the user may select the voice assistant control button on the hardware user interface of the playback device. Alternatively, the user may disable the voice assistant via the control device 830, by selecting the indication to disable the voice assistant within the microphone settings menu shown in FIG. 8B. In either case, the voice assistant will be disabled and the LED 707 may become unilluminated. Further, the playback device may play an audible indication 714, which may take the form of an announcement from the voice assistant that it has been turned off. Additionally, or alternatively, the playback device may play back an audio indication 715 that includes an audio tone or set of tones that signal the disabling of the voice assistant. Other indications are also possible.

The status of the playback device at the fourth point in time 711d may also be reflected in the setting menu on the control device 830, as shown in FIG. 8C. In particular, the voice assistant is now indicated as being disabled. However, the microphones are still on, and thus the Auto Trueplay and Sound Swap features are still shown as being enabled.

Moving to the fifth point in time 711e, the microphone switch 708 remains in the ON position and the user may reenable the voice assistant by either selecting the voice assistant control button on the playback device or by controlling the voice assistant enablement through the setting menu shown in FIG. 8C, as discussed previously. Accordingly, the LED 707 may become illuminated again and the playback device may play back one or more audio indications. For example, the playback device may play back an audio indication 716 that includes a voice assistant announcement that it has been turned back on, and/or the audio indication 713 that was initially played when the voice assistant was first enabled at the third point in time 711c. Further, the settings menu on the control device 830 may again indicate the respective statuses shown in FIG. 8B.

At the sixth point in time 711f, the user may move the microphone switch to the OFF position. As discussed above, this may disable all microphone-based features of the playback device. As a result, the LED 707 may become unilluminated to reflect that the voice assistant is no longer active. Further, the playback device may play back the audio indication 714 that was played at the fourth point in time 711d, including a voice assistant announcement that it has been turned off. In some embodiments, the voice assistant announcement might additionally or alternatively indicate that the microphones have been turned off. Similarly, the playback device may provide an audio indication 717 that includes one or more audio tones signaling that the microphones have been turned off. In this regard, the audio indication 717 may be different form the audio indication 715 played at the fourth point in time 711, which may indicate that the voice assistant was disabled while leaving the microphones enabled. In other examples, the playback device may play back the audio indication 715 in addition to, or instead of, the audio indication 717.

FIG. 8D provides an example of how the settings menu of the control device 830 may be updated when the microphone switch is moved to the OFF position. As shown, a top-level indication is provided that the microphone switch 708 has been moved to the OFF position, and that all microphones are turned off. Further, each of the individual microphone-based features are shown as being disabled, with an explanatory indication that the feature is disabled due to the microphones being turned off. This may help a user to understand that the features cannot be re- enabled from the settings menu unless the user moves the microphone switch 708 on the playback device to the ON position.

Returning to FIG. 7, at the seventh point in time 711g, the user may move the microphone switch 708 back to the ON position to reenable the microphones of the playback device. In this situation, the microphone-based features discussed above may be returned to the state they were in when the microphones were turned off. For instance, because each of the microphone-based features were turned on at the fifth point in time 711e, they are all reenabled at the seventh point in time 711f. Thus, the LED 707 may become illuminated again and the playback device may play back the audio indication 716 including the voice assistant announcement that it is back on. Similar to the microphone-based disabling of the voice assistant, when the voice assistant is reenabled as a result of turning the microphones back on, the announcement may additionally or alternatively indicate that the microphones have been turned back on. Further, the playback device may play back an audio indication 718 that may signal the enablement of the microphones. In this regard, the audio indication 718 may be the same as the audio indication 713, or it may be different from (and played back instead of, or in addition to) the audio indication 713.

Alternatively, if the user moved the microphone switch 708 to the OFF position following the fourth point in time 711d, when the voice assistant was disabled, the voice assistant may remain disabled when the microphone switch 708 is moved back to the ON position. As yet another possibility, the playback device may be configured such that the voice assistant always begins in a disabled state whenever the microphone switch 708 is moved from the OFF position to the ON position, regardless of the voice assistant's status when the microphones were turned off. Numerous other implementations are also possible.

In FIGS. 8A-8D, the example menu screens depicted the user of a single, cloud-based voice assistant. However, as discussed above, the playback device may be capable of supporting multiple simultaneous voice assistant services. In these situations, the separate voice assistants may appear as separately controllable items within the microphone settings menu, consistent with the examples and discussion above.

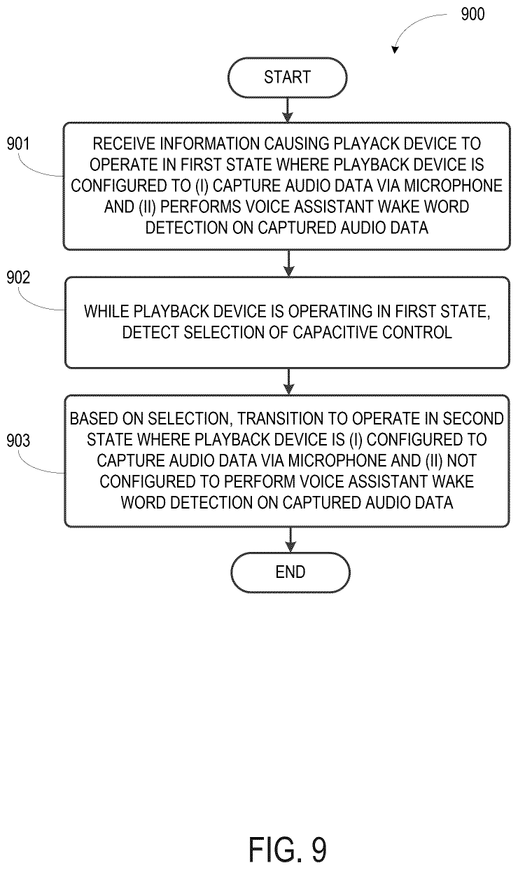

FIG. 9 is a flowchart 900 that illustrates one example implementation for enabling and disabling a voice assistant on a playback device separately from operation of the playback device's microphones. The flowchart 900 may involve an example playback device including at least one microphone as discussed above, such as any of the playback devices described in FIGS. 5-7. For purposes of discussing the flowchart 900, an example playback device 110 will be referred to.

Beginning at block 901, the playback device 110 may receive information that causes the playback device 110 to operate in a first state where the playback device is configured to capture audio data via the at least one microphone and perform voice assistant wake word detection on audio data captured by the at least one microphone. For example, the playback device 110 may receive information for linking to a voice assistant service (e.g., a cloud-based or local voice assistant service), as discussed above and generally shown at the third point in time 711c in FIG. 7 and in the settings menu shown in FIG. 8B. Thereafter, the playback device 110 may process captured audio content (e.g., using voice-processing components 124 including a wake word detection engine) to determine whether the captured audio content includes a wake work associated with the cloud-based voice assistant service.

At block 902, while the playback device 110 is operating in the first state, the playback device 110 may detect a selection of a voice assistant control button, which may take the form of a capacitive control on a surface of the playback device 110, which a user may select as described in the examples above.

At block 903, based on the selection of the voice assistant control button while the playback device 110 is operating in the first state, the playback device 110 may transition to operate in a second state, which is generally shown at the fourth point in time 711d in FIG. 7 and in the settings menu shown in FIG. 8C. In the second state, because only the voice assistant and not the microphones have been disabled, the playback device 110 may still be configured to capture audio data via the at least one microphone, as it was in the first state. However, the playback device 110 may no longer be configured to perform voice assistant wake word detection on audio data captured by the at least one microphone. For instance, the playback device 110 may disable the wake word detection engine while keeping other voice processing components 124 active, in order to facilitate other microphone-based features.

Further, as discussed in the examples above and shown in the figures, the playback device 110 may additionally be placed in a third state in which its microphone switch is moved to the OFF position, disabling the at least one microphone such that the playback device 110 is not configured to capture audio data via the microphones. Consistent with the discussion above, other states of the playback device 110 are also possible, including states in which the playback device 110 is configured to perform voice assistant wake word detection for multiple different wake words, as well as states in which the playback device 110 is configured to perform voice assistant wake word detection for only some wake words corresponding to linked voice assistant services, but not others.

Turning to FIG. 10, a schematic diagram of an example microphone circuit 1000 for a playback device is shown. The playback device of FIG. 10 may correspond to any of the microphone-equipped playback devices noted above, such as those discussion in relation to FIGS. 5-7. For purposes of discussing the microphone circuit 1000, an example playback device 110 will be referred to.

As shown in FIG. 10, the microphone circuit 1000 may include a power source 1112i, which may be similar to the power components 112i shown in FIGS. 1C and 1F and discussed above. For example, the power source 1112i may include an internal power source (e.g., a battery) if the playback device 110 is a portable playback device, otherwise the power source 1112i may be an external power source.

The microphone circuit 1000 also includes a microphone switch 1008, which may be the same as or similar to the microphone switches discussed above and shown in FIGS. 6-7. As can be seen in FIG. 10, the microphone switch 1008 may be a mechanical switch that physically disconnects two terminals of the microphone circuit 1000 when it is in the OFF position, thereby disconnecting the rest of the microphone circuit 1000 from the power source 1112i. When the microphone switch 1008 is in the ON position, the microphone circuit 1000 is closed and power can reach the other components in the circuit. Further, in some cases the microphone switch 1008 may include an actuator 1009 that the playback device may use, in some situations, to move the switch between the ON and OFF positions, as discussed above in relation to FIG. 6.

The microphone circuit 1000 also includes the microphones 1005, which receive power from a voltage regulator that is coupled to the power source 1112i. Further, the microphones 1005 may be digital microphones that transmit audio data, e.g., PDM (pulse-density modulation) audio data, to one or more processors 1112 of the playback device 110. The one or more processors 1112 may include audio processing components similar to the audio processing components 112g shown in FIG. 1C and/or the voice processing components 124 shown in FIG. 1F. Other configurations and other types of microphones are also possible.

The microphone circuit 1000 also includes an LED 1007, which is electrically coupled to a voice assistant control button 1006 via a microcontroller 1004. In this regard, the LED 1007 and voice assistant control button 1006 may resemble the LED 507 and voice assistant control button 506, respectively, shown in FIG. 5. Consistent with the discussion above, selection of the voice assistant control button 1006 may cause one or more signals to be transmitted that turn the LED 1007 on (or off), and that cause the one or more processors 1112 to perform (or stop performing) wake word detection of the audio data captured by the microphones 1005. Further, moving the microphone switch 1008 to the on position (or the off position) may cause one or more signals to be transmitted to the microcontroller 1004, which may update the state of the LED 1007 accordingly, according to the examples discussed above.

It will be appreciated that the microphone circuit 1000 provides just one example of how the electronics of the playback devices discussed herein may be arranged, and that other configurations that may achieve the same benefits are also possible.

Further, although the examples discussed herein are generally presented as providing benefits to playback devices in a media playback system and users thereof, the examples are also applicable to other types of voice-enabled devices that might be equipped with additional microphone-dependent features, such as smart home devices, IoT devices, and so on. Various other examples are also possible.

FIG. 9 includes one or more operations, functions, or actions as illustrated by one or more of operational blocks. Although the blocks are illustrated in a given order, some of the blocks may also be performed in parallel, and/or in a different order than those described herein. Also, the various blocks may be combined into fewer blocks, divided into additional blocks, and/or removed based upon the desired implementation.

In addition, for the flowchart shown in FIG. 9 and other processes and methods disclosed herein, the diagrams show functionality and operation of one possible implementation of present embodiments. In this regard, each block may represent a module, a segment, or a portion of program code, which includes one or more instructions executable by one or more processors for implementing logical functions or blocks in the process.

The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long-term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for the processes and methods disclosed herein, each block in FIGS. 5-8 may represent circuitry and/or machinery that is wired or arranged to perform the specific functions in the process.

While discussions herein generally describe separate controls for turning the microphone on and off and turning the voice assistant on and off, one having ordinary skill will appreciate that other configurations that offer comparable separation of microphone and voice assistant activations are also possible. For instance, a single three-way switch may be configured such that at a first position, both the microphone and accordingly the voice assistant are OFF; at a second position, the microphone is ON, but the voice assistant is OFF; and at a third position, both the microphone and voice assistant are ON. Other examples are also possible.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A first playback device comprising:
at least one microphone;
a capacitive control, disposed on a housing of the first playback device, for controlling a voice assistant status of the first playback device;
at least one processor;
at least one non-transitory computer-readable medium; and
program instructions stored on the at least one non-transitory computer-readable medium that, when executed by the at least one processor, cause the first playback device to:
operate as part of a synchrony group with at least a second playback device;
detect, via the capacitive control, user input indicating a command to update the voice assistant status of the first playback device from a first state to a second state, wherein:
when the voice assistant status is in the first state, the first playback device is configured to (i) capture audio data via the at least one microphone and (ii) perform voice assistant wake word detection on audio data captured by the at least one microphone; and
when the voice assistant status is in the second state, the first playback device is configured to (i) capture audio data via the at least one microphone and (ii) not perform voice assistant wake word detection on audio data captured by the at least one microphone; and
based on detecting the user input via the capacitive control:
update the voice assistant status of the first playback device from the first state to the second state; and
cause the second playback device to update a voice assistant status of the second playback device to the second state.

2. The first playback device of claim 1, wherein the program instructions that, when executed by the at least one processor, cause the first playback device to cause the second playback device to update the voice assistant status of the second playback device to the second state comprise program instructions that, when executed by the at least one processor, cause the first playback device to:
transmit, to the second playback device, a communication comprising (i) a command to set the voice assistant status of the second playback device to the second state, and (ii) an indication of a command for the second playback device to revert to a previous voice assistant status upon leaving the synchrony group.

3. The first playback device of claim 1, wherein the command is a first command, the first playback device further comprising program instructions stored on the at least one non-transitory computer-readable medium that, when executed by the at least one processor, cause the first playback device to:
while the voice assistant status of the first playback device is in the second state, detect, via the capacitive control, user input indicating a first command to update the voice assistant status of the first playback device to the first state;
based on detecting the first command, update the voice assistant status of the first playback device from the second state to the first state; and
forgo causing the second playback device to update the voice assistant status of the second playback device to the first state.

4. The first playback device of claim 1, wherein the command is a second command, the first playback device further comprising program instructions stored on the at least one non-transitory computer-readable medium that, when executed by the at least one processor, cause the first playback device to:
detect, via the capacitive control, user input indicating a first command to update the voice assistant status of the first playback device to the first state;
based on receiving the user input indicating the first command:
determine that no voice assistant service (VAS) is associated with the first playback device;
cause the first playback device to output an audible indication that a VAS is not associated with the first playback device; and
cause a control device configured to communicate with the first playback device to display a user interface view for associating a VAS with the first playback device.

5. The first playback device of claim 1, further comprising program instructions stored on the at least one non-transitory computer-readable medium that, when executed by the at least one processor, cause the first playback device to:
receive, from the second playback device, an indication that the voice assistant status of the second playback device has been updated from the second state to a third state wherein, when the voice assistant status is in the third state, the first playback device is configured to (i) capture audio data via at least one microphone of the first playback device and (ii) perform voice assistant wake word detection on audio data captured by the at least one microphone for a first voice assistant, but not a second voice assistant, that are both installed on the first playback device; and
based on receiving the indication from the second playback device, update the voice assistant status of the first playback device from the second state to the third state.

6. The first playback device of claim 5, further comprising:
a light emitting diode (LED); and
program instructions stored on the at least one non-transitory computer-readable medium that, when executed by the at least one processor, cause the first playback device to:
output, via the LED, a visual indication reflecting the current voice assistant status of the first playback device.

7. The first playback device of claim 6, wherein the visual indication comprises:
(i) illumination of a first color when the voice assistant status of the first playback device is in the first state, (ii) no illumination when the voice assistant status of the first playback device is in the second state, and (iii) illumination of a second color when the voice assistant status of the first playback device is in the third state.

8. The first playback device of claim 1, further comprising:
a microphone switch, disposed on the housing of the first playback device, for controlling a microphone status of the first playback device; and
program instructions stored on the at least one non-transitory computer-readable medium that, when executed by the at least one processor, cause the first playback device to:
detect that the microphone switch has been moved from an ON position to an OFF position;
based on detecting that the microphone switch has been moved to the OFF position:
output an audible indication that the first playback device has discontinued capturing audio data; and
cause the second playback device to discontinue capturing audio data via at least one microphone of the second playback device.

9. The first playback device of claim 8, wherein the program instructions that, when executed by the at least one processor, cause the first playback device to cause the second playback device to discontinue capturing audio data via at least one microphone of the second playback device comprise program instructions that, when executed by the at least one processor, cause the first playback device to:
transmit, to the second playback device, a command to cause a mechanical actuator of the second playback device to move a microphone switch of the second playback device to the OFF position.

10. The first playback device of claim 8, further comprising program instructions stored on the at least one non-transitory computer-readable medium that, when executed by the at least one processor, cause the first playback device to:
transmit, to the second playback device, a command to not capture any audio data via the at least one microphone of the second playback device.

11. The first playback device of claim 1, further comprising program instructions stored on the at least one non-transitory computer-readable medium that, when executed by the at least one processor, cause the first playback device to:
a microphone switch, disposed on the housing of the first playback device, for controlling a microphone status of the first playback device; and
program instructions stored on the at least one non-transitory computer-readable medium that, when executed by the at least one processor, cause the first playback device to:
detect that the microphone switch has been moved from an ON position to an OFF position; and
based on detecting that the microphone switch has been moved to the OFF position:
output an audible indication that the first playback device has discontinued capturing audio data; and
cause one or both of the first or second playback devices to output an audible indication that the second playback device has not discontinued capturing audio data.

12. A non-transitory computer-readable medium, wherein the non-transitory computer-readable medium is provisioned with program instructions that, when executed by at least one processor, cause a first playback device to:
operate as part of a synchrony group with at least a second playback device;
detect, via a capacitive control disposed on a housing of the first playback device for controlling a voice assistant status of the first playback device, user input indicating a command to update the voice assistant status of the first playback device from a first state to a second state, wherein:
when the voice assistant status is in the first state, the first playback device is configured to (i) capture audio data via at least one microphone of the first playback device and (ii) perform voice assistant wake word detection on audio data captured by the at least one microphone; and
when the voice assistant status is in the second state, the first playback device is configured to (i) capture audio data via the at least one microphone and (ii) not perform voice assistant wake word detection on audio data captured by the at least one microphone; and
based on detecting the user input via the capacitive control:
update the voice assistant status of the first playback device from the first state to the second state; and
cause the second playback device to update a voice assistant status of the second playback device to the second state.

13. The non-transitory computer-readable medium of claim 12, wherein the program instructions that, when executed by at least one processor, cause the first playback device to cause the second playback device to update the voice assistant status of the second playback device to the second state comprise program instructions that, when executed by at least one processor, cause the first playback device to:
transmit, to the second playback device, a communication comprising (i) a command to set the voice assistant status of the second playback device to the second state, and (ii) an indication of a command for the second playback device to revert to a previous voice assistant status upon leaving the synchrony group.

14. The non-transitory computer-readable medium of claim 12, wherein the command is a first command, and wherein the non-transitory computer-readable medium is also provisioned with program instructions that, when executed by at least one processor, cause the first playback device to:
while the voice assistant status of the first playback device is in the second state, detect, via the capacitive control, user input indicating a first command to update the voice assistant status of the first playback device to the first state;
based on detecting the first command, update the voice assistant status of the first playback device from the second state to the first state; and
forgo causing the second playback device to update the voice assistant status of the second playback device to the first state.

15. The non-transitory computer-readable medium of claim 12, wherein the command is a second command, and wherein the non-transitory computer-readable medium is also provisioned with program instructions that, when executed by at least one processor, cause the first playback device to:
detect, via the capacitive control, user input indicating a first command to update the voice assistant status of the first playback device to the first state;
based on receiving the user input indicating the first command:
determine that no voice assistant service (VAS) is associated with the first playback device;
cause the first playback device to output an audible indication that a VAS is not associated with the first playback device; and
cause a control device configured to communicate with the first playback device to display a user interface view for associating a VAS with the first playback device.

16. The non-transitory computer-readable medium of claim 12, wherein the non-transitory computer-readable medium is also provisioned with program instructions that, when executed by at least one processor, cause the first playback device to:
receive, from the second playback device, an indication that the voice assistant status of the second playback device has been updated from the second state to a third state wherein, when the voice assistant status is in the third state, the first playback device is configured to (i) capture audio data via at least one microphone of the first playback device and (ii) perform voice assistant wake word detection on audio data captured by the at least one microphone for a first voice assistant, but not a second voice assistant, that are both installed on the first playback device; and
based on receiving the indication from the second playback device, update the voice assistant status of the first playback device from the second state to the third state.

17. The non-transitory computer-readable medium of claim 16, wherein the non-transitory computer-readable medium is also provisioned with program instructions that, when executed by at least one processor, cause the first playback device to:
output, via a light emitting diode (LED) of the first playback device, a visual indication reflecting the current voice assistant status of the first playback device.

18. The non-transitory computer-readable medium of claim 12, wherein the non-transitory computer-readable medium is also provisioned with program instructions that, when executed by at least one processor, cause the first playback device to:
detect that a microphone switch, disposed on the housing of the first playback device, for controlling a microphone status of the first playback device, has been moved from an ON position to an OFF position; and
based on detecting that the microphone switch has been moved to the OFF position:
output an audible indication that the first playback device has discontinued capturing audio data; and
cause the second playback device to discontinue capturing audio data via at least one microphone of the second playback device.

19. A method carried out by a first playback device, the method comprising:
operating as part of a synchrony group with at least a second playback device;
detecting, via a capacitive control disposed on a housing of the first playback device for controlling a voice assistant status of the first playback device, user input indicating a command to update the voice assistant status of the first playback device from a first state to a second state, wherein:
when the voice assistant status is in the first state, the first playback device is configured to (i) capture audio data via at least one microphone of the first playback device and (ii) perform voice assistant wake word detection on audio data captured by the at least one microphone; and
when the voice assistant status is in the second state, the first playback device is configured to (i) capture audio data via the at least one microphone and (ii) not perform voice assistant wake word detection on audio data captured by the at least one microphone; and
based on detecting the user input via the capacitive control:
updating the voice assistant status of the first playback device from the first state to the second state; and
causing the second playback device to update a voice assistant status of the second playback device to the second state.

20. The method of claim 19, wherein causing the second playback device to update the voice assistant status of the second playback device to the second state comprises:
transmitting, to the second playback device, a communication comprising (i) a command to set the voice assistant status of the second playback device to the second state, and (ii) an indication of a command for the second playback device to revert to a previous voice assistant status upon leaving the synchrony group.
